(19) United States
(12) Patent Application Publication
(10) Pub. No.: US 2014/0013447 A1
(43) Pub. Date: Jan. 9, 2014

(54) Method for User Access Control in a Multitenant Data Management System

(71) Applicant: Basware Corporation, Espoo (FI)

(72) Inventor: Timo HOTTI, Lohja (FI)

(21) Appl. No.: 13/926,090

(22) Filed: Jun. 25, 2013

(30) Foreign Application Priority Data
Jul. 4, 2012 (FI) FI20120222

(51) Int. Cl. G06F 21/62

(52) U.S. Cl. CPC G06F 21/6209
USPC 726/28

(57) ABSTRACT

The invention discloses a computer executable method for managing user's access to a service adapted to access a data object in a multitenant data management system. The method is characterized in that the method comprises the steps of determining data object's association with an entity, determining the existence of a trust relationship between the user and the entity in the context of the service, determining the user's access rights to the data object, and granting the user access to the service, if the data object is determined to be associated with the entity, the trust between the entity and the user is determined to be valid in the context of the service, and the user is determined to have valid access rights to the data object. Also a computer program product is disclosed.

### BACKGROUND

Social networking has gained significant popularity as a means to exchange information between individuals. Social network services allow users to establish links to trusted users (“friends”) and share information with the friends. The data of the social network is typically managed in a multitenant data management system. Access to the data of an individual is managed by each individual separately.

Because of the popularity of social networks in the private life of people, the same information sharing methods have been introduced also in businesses. Employees of an organization may establish a closed social network within the organization and communicate within the network about some business information using the similar ways of communication that they are accustomed to in their private life.

When extending social network-style communication from inside a single organization to a multi-organization domain, there are numerous issues related e.g. to the authorization of users to access the data of the network.

First, an organization needs to be able to control in a simple, yet efficient manner, how its members (e.g. employees of a company) represent the organization in a public network, possibly in multiple different contexts of communication.

Second, the network may contain business critical and confidential documents of a large number of organizations. An individual document may have multiple stakeholder companies. For example, an invoice document has always a seller and a buyer as stakeholders. Additionally, some other organizations may participate in the processing of the documents. This data must be easily shareable between users that may belong to any of the stakeholder organizations. However, users of an organization that does not hold an appropriate stake to a document must not be able to see the document, nor any of the data that is based on the document, under any circumstances.

Third, the social networks largely rely on self-administering users. In other words, a central administration function, that typically relies on role-based access control, is not feasible for handling access control data of individual users or organizations. The access control method of a cross-domain business social network should advantageously be compatible with the concept of self-administration.

It is an object of the present invention to provide an access authorization method and arrangement for a service, e.g. a communication service, of a cross-domain business social network that may be based e.g. on a multitenant business transaction data management system. It is desirable that at least some of the above mentioned issues left open in the prior art solutions are addressed by some embodiments of the invention.

### BRIEF DESCRIPTION OF THE INVENTION

The first aspect of the invention is a computer executable method for managing user's access to a service, e.g. a communication service, wherein the service is adapted to access a data object in a multitenant data management system comprising data of a plurality of entities. The method is characterized in that the method comprises the steps of determining the data object's association with an entity, determining the existence of a trust relationship between the user and the entity for the user to represent the entity in the context of the service, determining the user's access rights to the data object, and granting the user access to the service, if the data object is determined to be associated with the entity, the trust between the entity and the user is determined to be valid in the context of the service, and the user is determined to have valid access rights to the data object.

The entity may be e.g. a representable entity, e.g. an organization or a legal entity.

The data object may be e.g. a document, e.g. an invoice, purchase order or a contract. Preferably, the data object comprises at least some business transaction data that is representable in a predetermined data structure.

The service may be e.g. a communication service adapted to exchange information between the user and a second user wherein the second user has a trust relationship, in the context of the service, e.g. with a second representable entity.

The context data may be adapted to be maintainable by the data management system and shareable by a plurality of services arranged to access the data of the data management system.

The step of determining the validity of trust between the organization and the user may comprise the step of determining the validity of a chain of trust comprising a plurality of trust objects wherein the chain has at least one object representing a third user who has a trust association with the organization in the context of the service and who has established a trust relationship with another user, e.g. the first user to delegate the trust received from the organization.

The step of checking the validity of the chain of trust between the user and the organization may comprise the steps of a) selecting a trust link associated with the user where the context information of the link matches with the context information of the service of the permission request, b) traversing to a second trust link specified in the trust link, repeating steps a) and b) until the end of the chain has been reached, and verifying whether the entity in the end of the chain is an organization that is a stakeholder to the data object to which access permission is requested.

In an embodiment, the communication service may comprise steps for creating a second data object comprising a task executable in a second application service, and sending the second data object to the second application service to be executed in the second application service using local user identifier associable with the first user or the third user.

The step of determining user's access rights to the data object may comprise the step of reading access control information obtained from an external system arranged to manage at least a partial copy of the data object.

The method may comprise also the step of determining data object's association with a second organization wherein the association with the second organization is verified by checking the existence of at least one event being associable with the data object and having a property confirming the validity of the association of the data object with the first and second organizations and/or establishment of a business relationship between the first and second organizations.

In an embodiment, the second user is associable, e.g. via a trust relationship, with the second organization. In an embodiment, the permission for the first user to access the function of the communication service to communicate with the second user is granted only, if there exists a valid association between the data object and the second organization and/or the second user is trusted, either directly or via a chain of trust, by the second organization in the context of the communication service.

The step of granting access to the function of the communication service may comprise generating a usage log entry identifying any or any combination of the following: the communication service function accessed, the data object concerned, the authorized first user to whom access was granted, and at least one third user whose trust link was used in the process of verifying the existence and validity of the chain of trust between the authorized user and the organization. A user, e.g. the third user, associable with the log entry may be granted access to the data of the log entry e.g. for the purpose of enabling the user to monitor the use of the trust of the user.

The communication service may be adapted to write data to a second data object wherein the second data object comprises information related to a collaborative process regarding the data object of the first aspect of the invention.

The method may also comprise the step of verifying, before granting user access to the function, using the log entries, the current validity of the previous authorizations related to the communication service, the data object and/or the second data object associable with the data object and the communication service.

The step of verifying the validity of the association between the organization and the data object may comprise e.g. any of the following: checking for the existence and/or validity of a link object that links the data object and the organization together, analysing the content of the data object, analysing content of a second data object associable with the data object, analysing content of a meta data object associated with the data object, and analysing content of a permission object associated with the data object.

The step of determining the user's access rights to the document may comprise checking for the existence of a permission link object that links the data object and the user together wherein the link object has been created utilizing data received from an external system that manages a copy of the data object, the received data comprising any of the following: access control list data, and usage log data.

The step of determining user's access rights to the data object may comprise the steps of traversing the chain of trust and searching the usage log to identify a trusted user having utilized access rights to the data object.

The function of the communication service may comprise a read operation or a write operation. In an embodiment, the authorization entitles user to perform a read operation on the data object and a write operation on the second data object that is associable with the communication service.

Advantageously, the method is implemented using data stored in a computer memory of e.g. server computer and utilizing instructions executable by the processor of the computer.

In an embodiment, the object that associates the data object and the organization together is created utilizing the results of an analysis executed on the content or meta data of the data object. The meta data may comprise e.g. routing information of a document transmitted in a document transmission network.

The second aspect of the invention may be a computer executable method for importing a data object from a first computer system to a second computer system e.g. for use of the multitenant service of the method of the first aspect of the present invention. The method is characterized in that it comprises computer executable steps for receiving the data object from the first computer system, storing the data object in the memory of the second computer system, analysing the content of the data object or its meta data for the purpose of identifying at least one organization, preferably a plurality of organizations as stakeholders of the data object, establishing an stakeholder association between each identified organization and the data object, and establishing a permission association between the data object and for at least one user of at least one identified organization.

The association may be e.g. a data object comprising references to the entities between which the association is formed.

The third aspect of the present invention may be a computer executable method for importing data from a first computer system to a second computer system for the purpose of maintaining access control data of data objects in the second computer system. The method is characterized in that it comprises steps for receiving data related to access rights or usage history of a data object from the first computer system, the received data comprising identification information associable with at least one user or user group of the second computer system, and creating in the memory of the second computer system a permission link object that associates a data object stored in the memory means of the second computer system with at least one user object stored in the memory means of the second computer system and that optionally comprises information regarding the basis of the creation of the link object.

The information regarding the basis of the creation of the permission link object may comprise e.g. any of the following: access control list information about accessing in the first computer system data related to the data object of the second computer system, and usage log information about accessing in the first computer system data related to the data object of the second computer system.

In an embodiment, a user who has trusted a second user to represent him/herself in the context of at least one service in the second computer system, is provided means to monitor and/or approve the activities performed by the second user based on the trust.

Another aspect of the present invention is an arrangement comprising at least one server computer. The arrangement is adapted to comprise means for performing the steps a method disclosed herein.

Yet another aspect of the present invention is a computer program product stored on a computer readable storage medium. The product is adapted to comprise computer executable instructions for the purpose of performing a combination of steps of a method disclosed herein.

### DRAWINGS

Some preferred embodiments of the invention are described below with references to accompanied figures, where:

FIG. 1a depicts an exemplary arrangement of servers and terminals according to an embodiment of the present invention,

FIG. 1b depicts in more detail some functional components and interfaces of the master data management server of an embodiment of the present invention,

FIGS. 2a-d illustrate some key objects and components and relations between them according to some preferred embodiments,

FIGS. 3a-b depict relations and interactions between organizations, users and documents (transactions) according to some preferred embodiments,

FIGS. 4a-e illustrate management of various data objects of some embodiments of the invention,

FIGS. 5a-b illustrate exemplary methods of access authorization according to some preferred embodiments of the invention,

FIG. 6 illustrate a method of integrating the access control method of an embodiment of the present invention with the access control method of a second system, and

FIG. 7 illustrates components of an exemplary computer usable for executing various embodiments of the present invention.

### DETAILED DESCRIPTION OF THE INVENTION

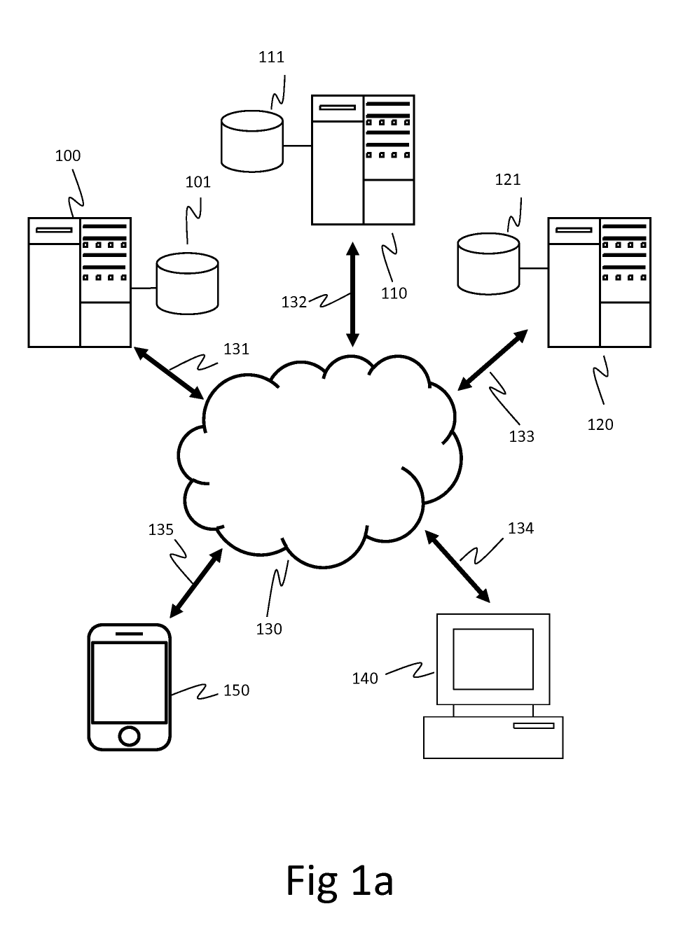

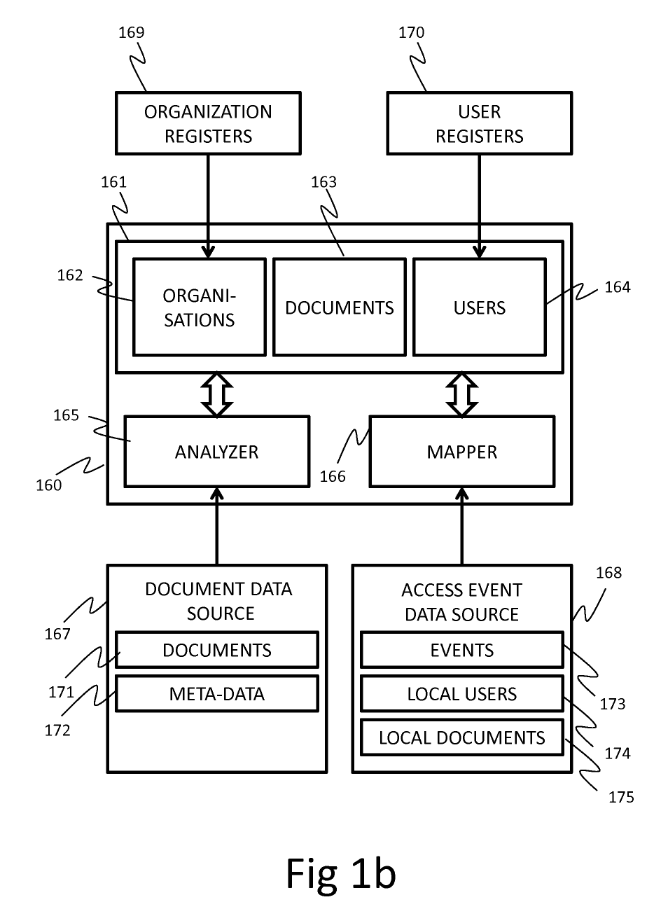

FIG. 1a depicts a computer and data communication arrangement according to a preferred embodiment of the present invention.

The server computer 100 is a source of documents, e.g. a router of a document routing network or a server providing an application service that creates documents, e.g. invoices. The computer 100 sends copies of documents, e.g. invoices, purchase orders or contracts, to another server computer 110 of the system via data exchange interfaces 131, 132 and a data communication network 130. A copy of the sent documents may reside also in the data storage 101 of the server 100. There may be any number of server computers 100 in the system.

The server computer 110 is the master data management server of the documents and other data of the system. In a preferred embodiment, there may be any number of server computers which together provide the master database server functionality. The master data is stored in the storage 111 of the server. Advantageously, the storage 111 comprises business documents (transactions) which each are associable with multiple stakeholder organizations and which are accessible by a plurality of users. The organization data and user data are part of the master data and are thus also stored in the storage 111 of the server 110. In addition to managing the master data of the system, the server computer 110 acts as an application server, e.g. as a collaboration server. The server 110 may thus act as the provider of collaboration services between users who represent stakeholders of a document. The users may access the master data via a plurality of terminal computers 140, 150 that are communicatively connected 135, 134 to the data communication network 130 through the application services provided by the server computer 110.

The server computer 120 depicts a back-end application server that is communicatively connected 133 to the data communication network 130, e.g. the Internet. The server computer 120 may provide additional services related to the documents managed by the system. A copy of at least some of the document data of the system may be stored in the storage 121 of the server. There thus may be one copy of a document in the storage 121 and another copy in the storage 111. In an embodiment, the back-end application server may provide e.g. invoice automation services such as invoice life cycle management services, e.g. invoice approval services. There may be any number of servers 120 in the system. For example, there may be separate servers for each organization subscribing to some application service, e.g. an invoice automation service. In a preferred embodiment, the server 120 has a data exchange interface with the server 110 for the purpose of exchanging document-related data, e.g. access event data, event data or tasks between the servers 110 and 120. There may also be a data exchange interface between the servers 100 and 120 for the purpose of exchanging document data and/or supplementary data related to the documents between the servers.

FIG. 1b depicts in more detail functional software components of the master data management server 160 (110 and 111 in FIG. 1a) as well as its interfaces with external data sources. The master data management server comprises a data management component 161 which manages, among other data, data related to documents 163 (business transactions), users 164 who may have access to the documents and organizations 162 who may be stakeholders to the documents. The users 164 are identified by global user IDs, the documents 163 are identified by global document IDs and the organizations 162 are identified by global organization IDs. A global ID here means an ID that is unique in the multitenant database of the master data management server 110. Additionally, the data management component manages the data that links these three main data entities together. The server 160 additionally comprises two software components for maintaining the data of the data management component. The analyzer component 165 receives document data from at least one document data source 167 (e.g. server computer 100 or 120). The document data source may provide document data 171 as well as document meta-data 172 to the analyzer 165. The mapper component 166 receives access event data from at least one access event data source 168. The data source may be e.g. an electronic invoicing application, purchase order management application or a contract management application or any other application capable of processing business document data, e.g. invoices, purchase orders or contracts, associable with at least one, preferably multiple organizations. In an embodiment, the data source for document and access event data may be a router of a content routing network. The access event data 173 may comprise e.g. access control list information or access log information. The access event data typically identifies a user who has performed an action on a document in the access event data source, the action performed and the document concerned. The mapper component maps the received access event data with information of the data management component 161 and updates, based on the mapped event data, information in the data management component 161. The mapping operation performed by the mapper 166 comprises typically step of mapping a local user ID 174 of the data source to the global user ID of the master data management system and a local document ID 175 of the data source to the global document ID of the master data management system. The mapped event data may then be utilized to update the data of the data management component 161.

The organization data 162 may be at least partially maintained using data available from external organization registers 169. Similarly, the user data 164 may be maintained at least partially using data of external user registers 170, e.g. identity management services.

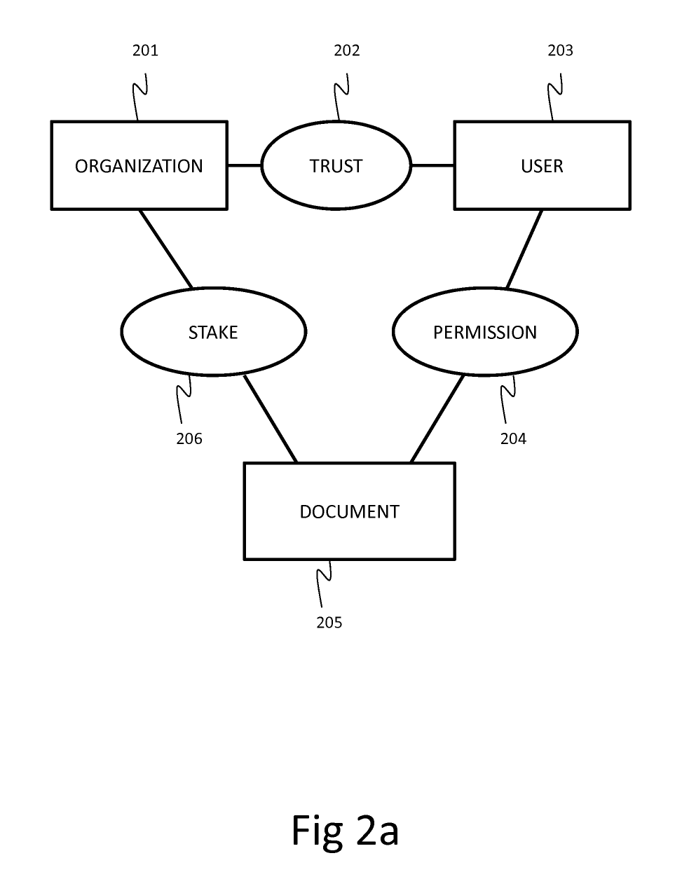

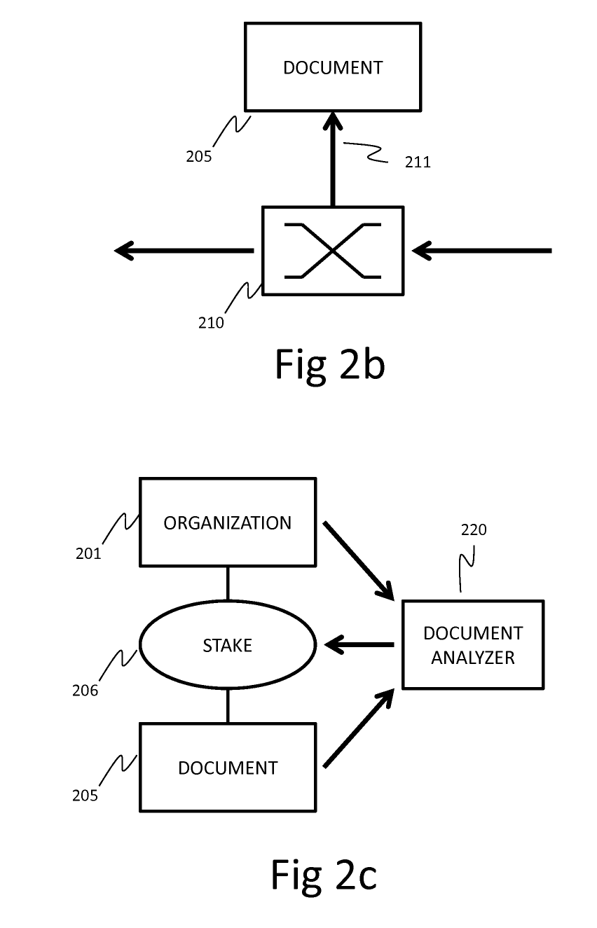

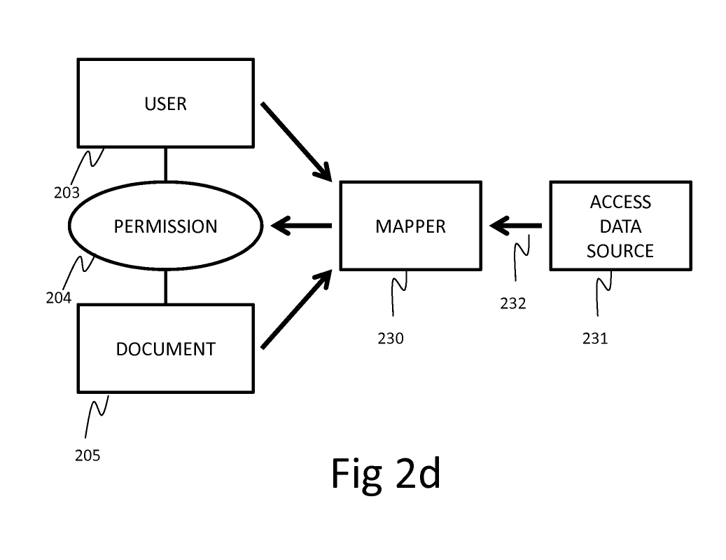

FIG. 2a depicts an exemplary overview of the master data managed by the data management component (161 in FIG. 1b) of the server (160 in FIG. 1b, 110 and 111 in FIG. 1a) of an embodiment of the present invention. The master data comprises three main classes: organization data 201, user data 203 and document data 205. An organization may act as a stakeholder 206 of a business document 205. For example, an organization 201 may be a seller or buyer party of an invoice. An organization may be represented by at least one, preferably by a plurality of users 203 through a trust relationship 202. In a preferred embodiment, the trust relationship 202 specifies a context in which the user 203 may represent the organization 201. The representation may occur e.g. via a service that is associated with the context. For example, an organization may trust a user to represent the organization in all invoicing related contexts or in a specific invoicing related context, e.g. collaboration processes between organizations that aim towards a dispute resolution. The available contexts and their association with services may be defined and maintained e.g. in the access control services of the master data management platform running on computer 110. A context may be associated, e.g. by the operator of the access control services, with any number of services. For example, there may be multiple different (complementing or alternative) services for the context of dispute resolution of invoices. The services may be provided by different service providers. In an embodiment, a service may be associated with multiple different contexts. For example, an invoice dispute resolution service may be associated with an invoicing context and with a dispute resolution context. In order for a user to use such service as a representative of an organization, the user should be trusted by the organization in both contexts. In the embodiment shown, the user 203 is further linked to at least one document 205 via a permission link (relationship) 204. The permission 204 may specify which kind of access the user has to the document. The access permission may be e.g. for a read access or for a read/write access. The permission may also contain information about the basis of the permission. One basis for a user to have access to a document may for example be that the same user has access rights to a copy of the document or has accessed the copy of the document in another system. Another basis for a user to have access to a document may be that another user, who the user trusts in a context, e.g. in communication regarding an invoice, e.g. a dispute case, has accessed the document in the context of the trust. A permission object 204 may thus be created between a first user and a document when a second user has accessed the document utilizing trust delegated to the second user by the first user. Yet another basis for a user to have access permission to a document may be e.g. a rule that has been defined in the established trust relationship. For example, the rule may specify that the user, to whom the trust has been granted, has access permission to the same documents to which the grantor of the trust has access permission.

In a preferred embodiment, the data model of FIG. 2a is used for user 203 access authorization purposes in a multitenant system comprising a plurality of organizations 201 and a plurality of documents 205, each document having at least one, preferably multiple, organizations as stakeholders. If a user 203 wants to represent an organization in a process involving a document, the user 203 needs to have established a trust link (relationship) 202 with the organization 201, a permission link 204 to the document 205 and the organization 201 must be a stakeholder 206 of the document 205.

FIG. 2b depicts an exemplary arrangement for importing document data into document collection 205 to the storage 111 of server 110. The arrangement comprises a source of documents 210, for example a document router (100 in FIG. 1a). In a preferred embodiment, the document router is adapted to transmit business documents between stakeholders, e.g. invoices, purchase orders and/or contracts between buyers and sellers. The router may act as an intermediary between any number of stakeholders. The router may also be a node of a router network. Copies of the documents are transmitted from the source of documents to the document collection 205 using a data exchange interface 211. The router may also transmit supplementary data associable with the business documents. Such data may comprise e.g. event information, state change information or access control information related to the business document.

The documents imported to the document collection 205 are analyzed using for example an arrangement shown in FIG. 2c. The analysis is needed to establish the stakeholding relationships 206 between organizations 201 and imported documents 205. The analysis is performed using a document analyzer component 220. The analyzer inspects the data of the imported document and determines based on its findings, which organizations are the stakeholders of the document. The inspected data may comprise the content of the document and/or meta-data, including routing data usable by the router 210, related to the document. The content of the document may contain e.g. the name and address information of the sender (seller) and recipient (buyer) of an invoice. In an embodiment, a specific combination of information may identify two stakeholders. E.g. the seller name specifies the seller but the associated address or other contact information specifies the financing company who performs the invoicing on behalf of the seller. In such case, both the seller and the financing company should be added as stakeholders of the document. The meta-data of the document may comprise e.g. routing information of the document in a document routing network or some data related to an activity performed on the document.

In an embodiment, a stake 206 between a document 205 and an organization 201 is established only, if there is at least one additional data item available that confirms the business relationship between two organizations. For example, sending an invoice document from an organization to another organization is not a sufficient act alone to make the receiving organization a stakeholder of the document and thus establish a business relationship between the organizations. The receiving organization may become a stakeholder, if the document analyzer 220 e.g. identifies a purchase order document that is associable with the invoice or if the document analyzer 220 identifies an event received from an external system, e.g. an invoice processing system that indicates that the invoice has been accepted by the receiving organization as a valid invoice.

In order for a user 203 to access a document 205, a permission link 204 must have been established between the user and the document. In some embodiments, some other applicable condition may be checked when determining user's access right to the document. FIG. 2d shows an exemplary arrangement for establishing the permissions. The arrangement comprises a mapper component, which receives information usable for establishing the permission from an access data source 231. The access data source may be e.g. a server of a back-end system (120 and 121 in FIG. 1a) which has a copy of the document 205 and which is capable of providing an application service regarding the document. The access data source 231 sends access data regarding users and documents to the mapper 230 via a data exchange interface 232. The access data may comprise e.g. access control list of a document or access history data (i.e. access log data) of the document. Typically an access data object comprises identifiers for a user and a document. The data that comes from the access data source 231 (120 in FIG. 1a) is specific to the application service and needs to be mapped to the data of the master data management system 110. For example, the user IDs (“local user IDs”) of the obtained access data are typically specific to the access data source. Therefore, the “local user ID” must be mapped with the corresponding user ID (“global user ID”) of the user 203 of the master data management system. Similarly, the document identifier of the back-end system (120 in FIG. 1a) may be different than what is used for the document 205 in the master data management system. The identifiers of the local systems must be mapped with the identifiers of the master data management system by the mapper component 230 before the permission object 204 between the user 203 and document 205 is established. The mapping information is advantageously managed by the master data management system 110.

In an embodiment, the mapper component also establishes a stakeholding relationship (206 in FIG. 2c) between an organization (201 in FIG. 2c) and the document 205. In an embodiment, the permission link may thus comprise also a stakeholding relationship (206 in FIG. 2c).

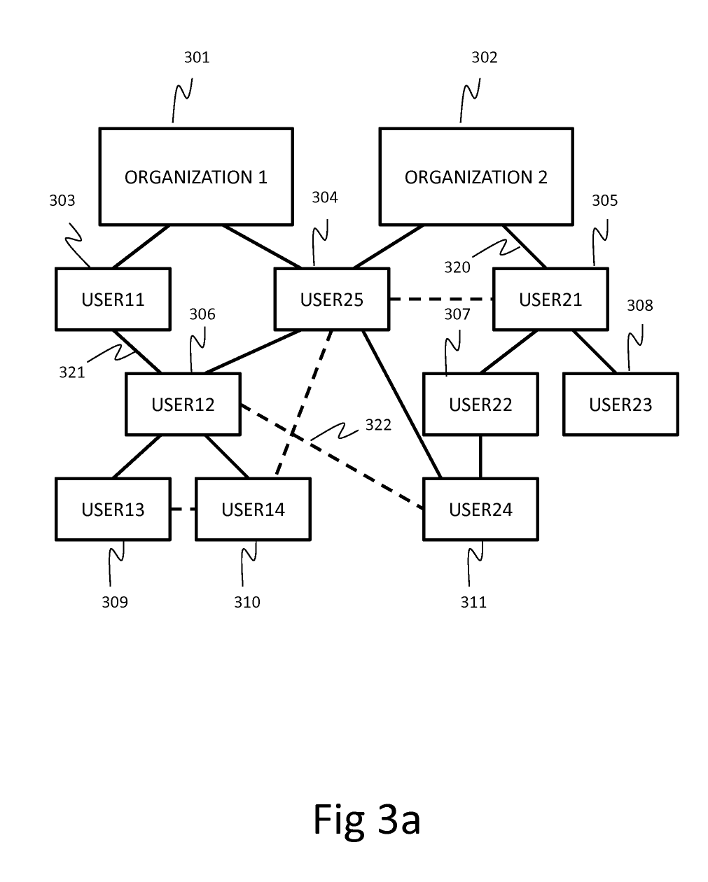

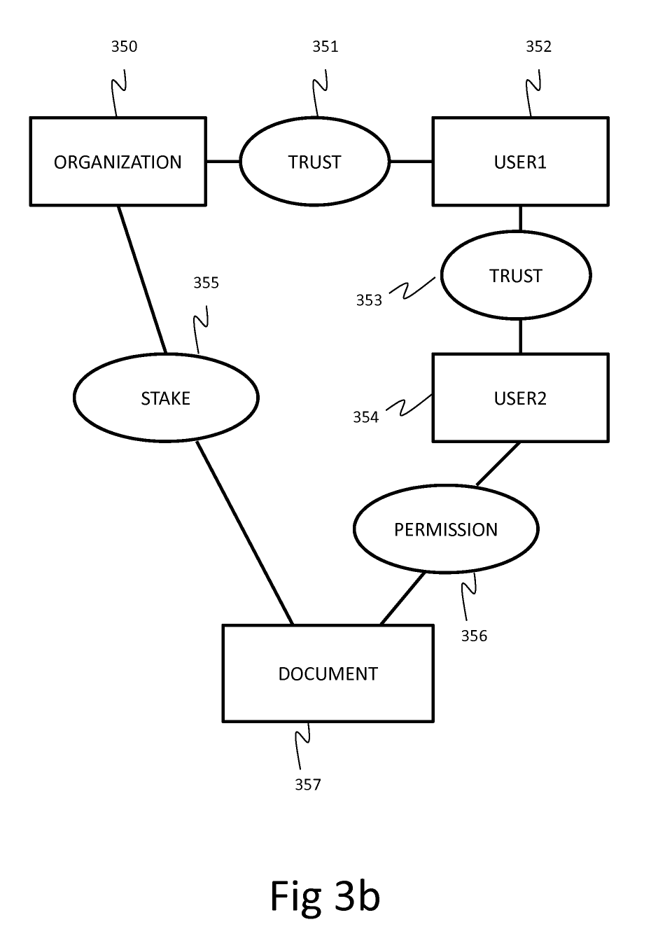

FIG. 3a shows an exemplary diagram of trust relationships on one hand between organizations and users and on the other hand between users. In the figure, each continuous line represents a trust relationship (e.g. 320) between an organization and a user or between users 321. A trust relationship allows the grantee user to represent the grantor in a context, e.g. a data exchange (communication) service provided between stakeholders of the document. For example, the trust connection 320 (202 in FIG. 2a) may authorize “USER21” 305 to represent the “ORGANIZATION 2” in a certain context, e.g in any communication regarding invoices of the organization, e.g. in the collaboration service of the master data management system (110 in FIG. 1a). The USER21 305 may delegate this trust further to another user, e.g. “USER22” 307 who is able to further delegate the trust to “USER24” 311. It is also noteworthy, that a single user, such as “USER25” 304, may be trusted by multiple organizations 301, 302. For example, the “USER25” 304 may provide invoicing services, e.g. invoice data validation services, to both organizations 301, 302. For this reason, both organizations have granted the user rights to represent the respective organizations e.g. in the context of invoice dispute management services provided e.g. by the master data management system (110 in FIG. 1a).

The dotted lines, e.g. 322, represent a “knows of” connection between users. Such connection does not establish any trust between the users in any context. These connections merely act as informative links in the social network between users of the master data management system.

FIG. 3b shows another exemplary diagram about the relationships of various objects of some preferred embodiments of the present invention. An organization object 350 is associated with a user object 352 through a trust object 351. The trust object gives the user 352 an authorization to represent the organization 350 in the context of e.g. a communication service, e.g. in a collaboration case within the organization 350 or between a plurality of organizations, of which one is the organization 350. The organization object 350 may also be associated with a data object, e.g. a document 357, through a stake object 355. The user 352 may delegate at least a part of the trust represented by the trust object 351 further to another user 354 by establishing another trust object 353 that is linked to the user 352 and the other user 354. The user 354 is granted access to the document 357 via a permission object 356. The permission object may be created e.g. based on access control information received from another system as shown in FIG. 2d. In an embodiment, the permission object may also be created based on information, e.g. some rules, of a trust object (351, 353).

In the embodiment shown in FIG. 3b, the user 352 does not have direct permission to access the document 357. On the other hand, the user 354 may represent the organization 350 in a context utilizing the trust 353 delegated to the user 354 by the user 352. For example, the user 354 may have created a dispute case about an invoice. In such case, the user 352 should be able to see the dispute case and all information related to the case even if there is no direct permission for the user 352 to see the data object (document) 357. In many cases, the user 352 should be able to see all activities of other users and the data of those activities where his/her trust has been used. In a preferred embodiment, user 352 is granted access to a data object 357 in a context, if the user is trusted in the context by the organization 350 that is a stakeholder 355 to the data object 357 and, there exists at least one user 354 that has utilized the trust 353 when accessing the data object 357. The utilization of the trust 353 in an authorization process where document 357 has been accessed by user 354 may be queried from the usage log of the system (not shown in figure). In an embodiment, a new permission object may be created between the document 357 and user 352 when the user 354 accesses the document 357 utilizing the trust 353.

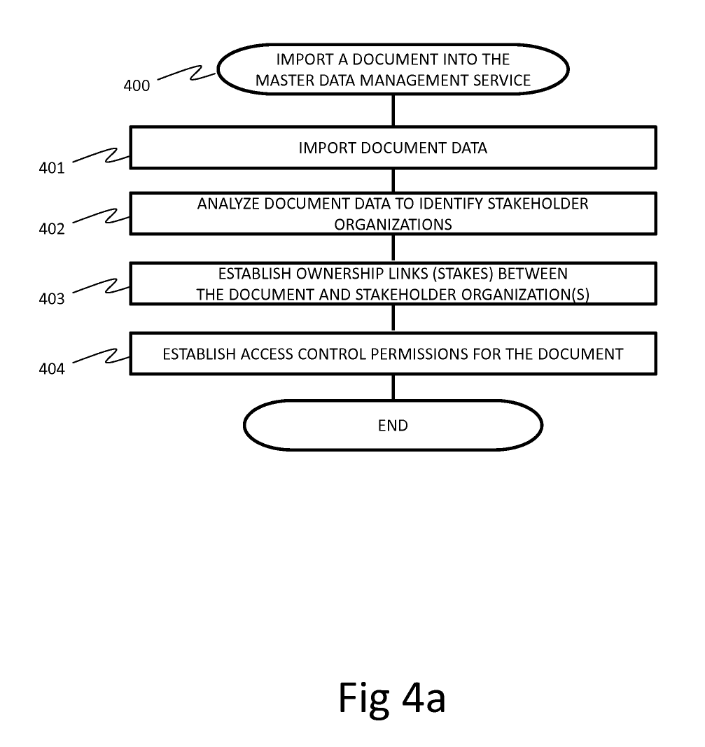

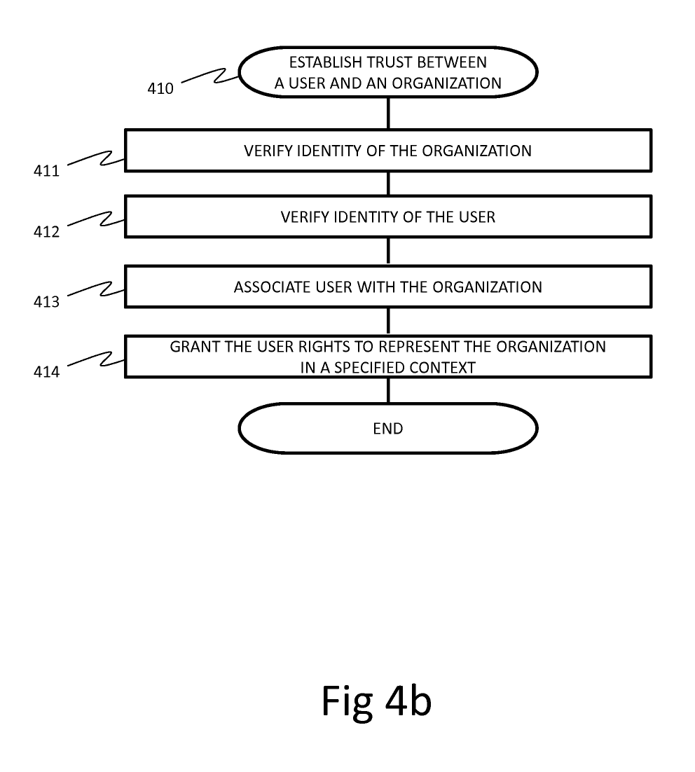

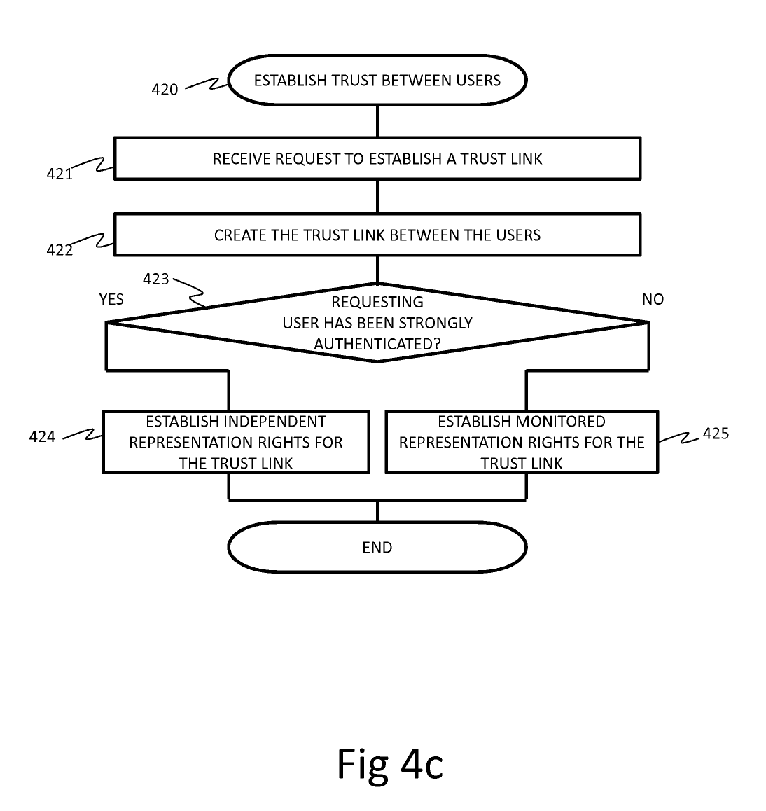

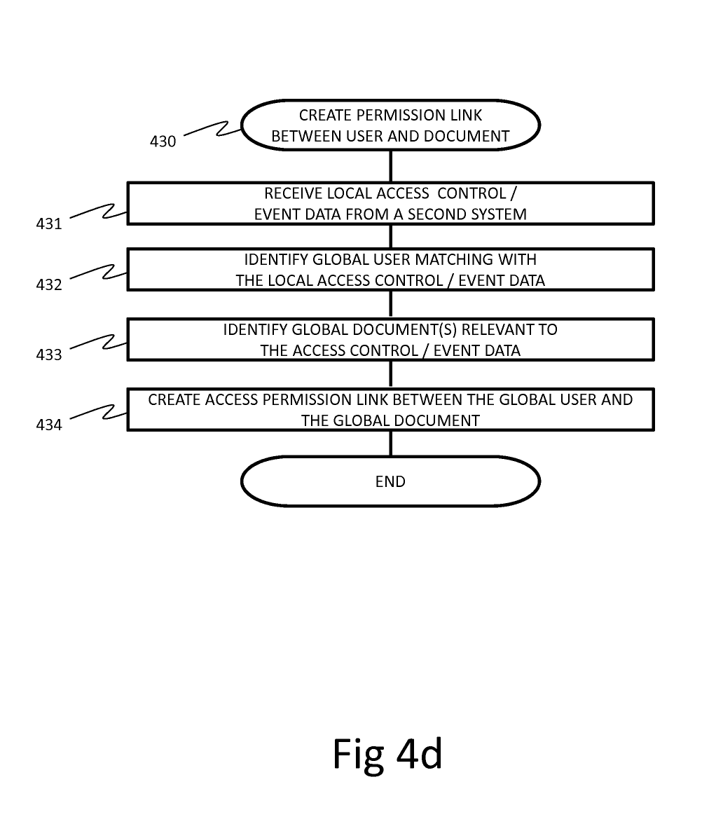

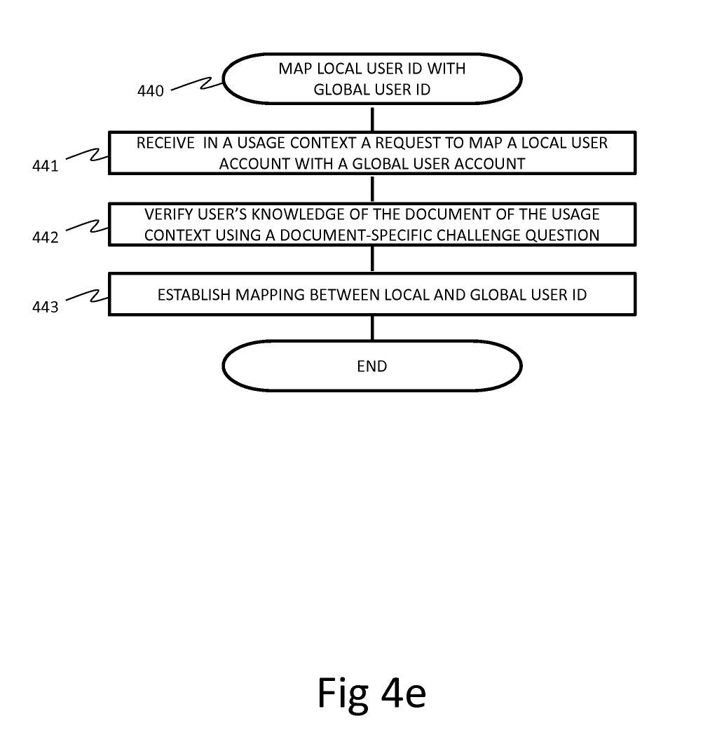

FIGS. 4a-e illustrate by means of flow charts various aspects of the methods of some preferred embodiments of the present invention. A method 400 for importing document data (205 in FIG. 2a) from a data source (e.g. 100 in FIG. 1a, 210 in FIG. 2b) into the master data management service (110 in FIG. 1a) is shown in FIG. 4a. In step 401, data of at least one document is transmitted from the data source to the master data management service. Then, the data and/or meta-data of the document is analyzed 402 for the purpose of identifying the stakeholders of the document. Next, ownership (stakeholder) links (206 in FIGS. 2a and 2c) are established 403 between the document and the identified stakeholder organizations. Finally, at least one access permission object (204 in FIG. 2a) is established between the document and a user of each stakeholder organization. The suitable users may be identified e.g. using some rules maintained in the master data management system (100 in FIG. 1a). In an embodiment, the superuser of each identified organization, e.g. a user who is directly trusted by the organization in all contexts, is automatically granted access to the documents. Other users may be granted access to the document based on the meta-data or content of the document. Additional access permissions to the document may be granted also later using e.g. method shown in FIG. 4d.

FIG. 4b depicts a method 410 of establishing a trust link between a user and an organization according to an embodiment of the present invention. In order to establish proper level of trust between an organization and a user, the identities of both the organization and the user must be verified 411, 412. For example, it must be checked, that there are no duplicates or fake instances in the organization data. It should also be verified, that the user represents a real person. Next, the user is associated with the organization 413 and the user is granted rights 414 (trust) to represent the organization. The rights may be limited to certain context, e.g. a service, such as an information exchanges service, e.g. a communication service, e.g. a collaboration service provided by the master data management system. The level of trust granted may also depend on the result of the verifications of steps 411 and/or 412. In an embodiment, the trust object may comprise instructions, e.g. rules, for creating access permissions to documents for the trusted user. For example, a trust object may specify, that the trusted user is allowed to have access to the same documents (or a subset of them) as the grantor of the trust.

FIG. 4c illustrates an exemplary method 420 of establishing trust between users. First, in step 421, a request to establish a trust link between two users is received. In an embodiment, the request has been created by a user who wishes to establish the trust link with another person in a context. In another embodiment, the request is created by a software process which has identified a relationship between the users. For example, event data received from an access event data source 168 may indicate, that the two users trust each other in the domain of another application. For example, the event data may reveal a supervisor-subordinate relationship. In the next step 422 of the method, a trust link (202 in FIG. 2a) between the users is established. In an embodiment, an approval for the new link is required from either or both of the users involved.

The users between whom the link is established, may have been authenticated strongly or weakly. Strong authentication means e.g. verification of the identity of the user by a trusted third party authentication service or by a trusted person. If the requesting user has been strongly authenticated 423, higher level of trust may be established 424 between the users. For example, the trust level may allow the grantee user to represent independently the grantor user in the context specified in the trust link. If, on the other hand, the grantee user has not been strongly authenticated, a lower level of trust may be established 425 between the users. The grantee user may for example receive monitored representation rights of the grantor user. This may for example mean that any action performed based on the granted trust link (202 in FIG. 2a), may need to be approved by the grantor of the trust link.

FIG. 4d depicts a method 430 for creating a permission link between a user and a document according to an embodiment of the present invention. The master data management system (160 in FIG. 1b, 110 in FIG. 1a) receives 431 data of a local access event (173 in FIG. 1b) from a second system, e.g. a event data source (168 in FIG. 1b). The received event data is accompanied with an ID of a local user (174 in FIG. 1b), i.e. user of the data source and an ID of a document (175 in FIG. 1b) in the data source system. The local user ID is mapped 432 with the global user ID of the master data management system and the local document ID is mapped 433 with the global document ID of the master data management system. Finally, an access permission link (204 in FIG. 2d) is created 434 between the global user and global document based on the event data received from the second system.

FIG. 4e depicts an exemplary method 440 of mapping a local user ID with a global user ID according to an embodiment of the present invention. In step 441, a request to map a local user ID with a global user ID is received. The request may be received in a usage context. For example, the local user of an electronic invoicing application requests mapping of his local user ID, i.e. the user ID used in the electronic invoicing application, with his global user ID, i.e. the user ID of the user in the master data management system, e.g. as part of a request to establish a collaboration session regarding an invoice in the master data management system (110 in FIG. 1a, 160 in FIG. 1b). Upon receipt of the request, the master data management system verifies 442 the user's knowledge of the document of the usage context using a document specific challenge. For example, the master data management system may query the total amount of an invoice, the buyers or sellers reference of the invoice or the name of the sender of the invoice. If the user is able to answer correctly to the challenge question(s), the master data management system establishes a mapping between the global user ID and the local user ID 443. Now the user is able to access the document data and the collaboration session data and services in the master data management system using his global user ID.

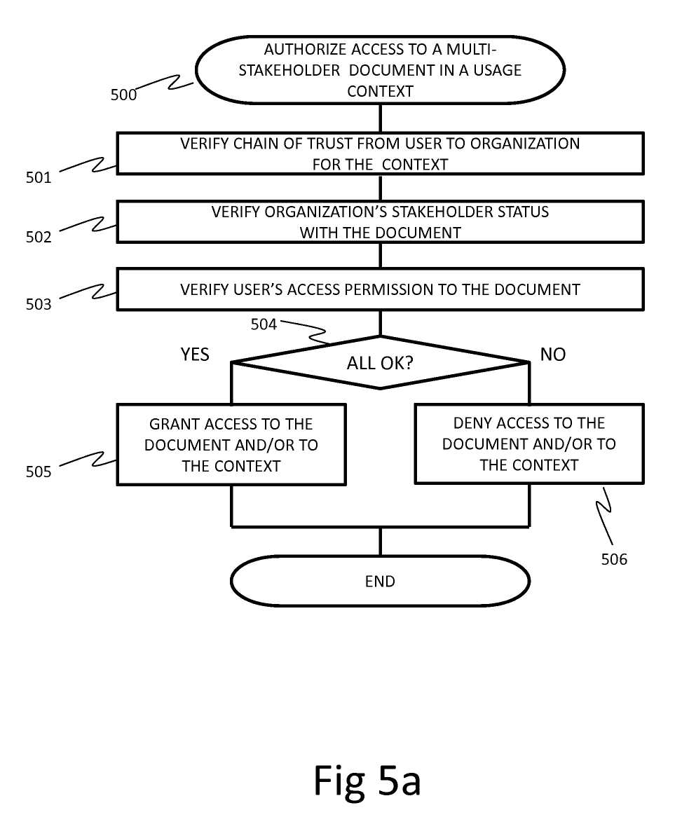

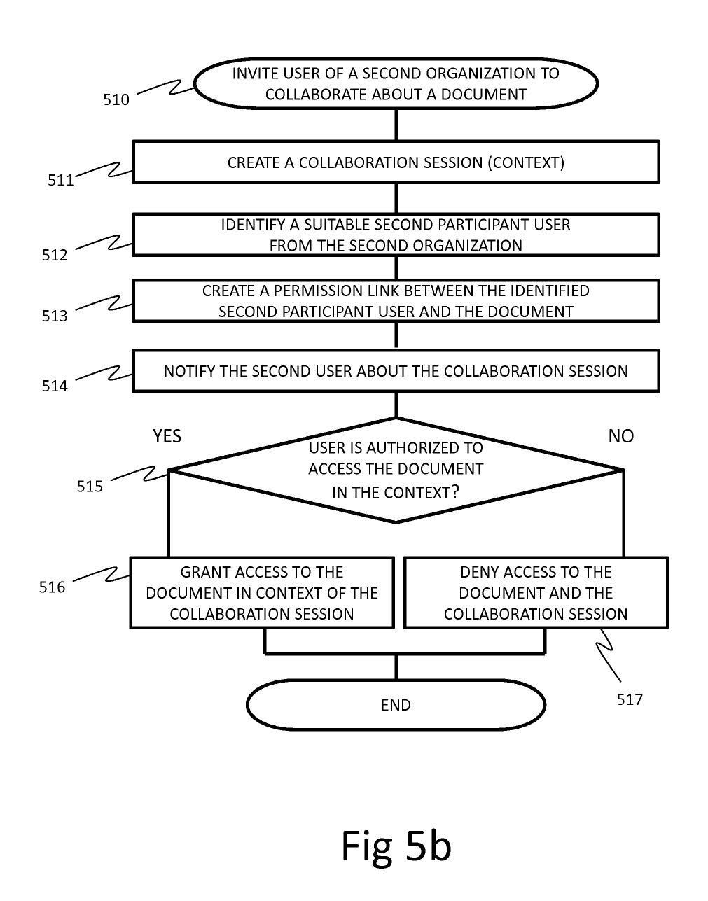

FIG. 5a illustrates an exemplary method 500 of authorizing user to access a multi-stakeholder document in the context of a service. The multi-stakeholder document is a document that is associable with multiple stakeholders (e.g. organizations). For example, an invoice is associable with a seller and a buyer. In order for a user to have access to a document in the context of the service, various conditions must be met. In step 501, the method verifies, that a chain of trust exists with the requesting user and an organization that is a stakeholder to the document. Each link in the chain of trust must allow user represent the company in the usage context. A context may be e.g. a certain service category, e.g. a collaboration process, within which services may be provided using the data of the master data management system. For each context, there may be multiple different services provided by multiple different service providers. Next, the method checks 502 validity of the organization's stakeholder status regarding the document. If the organization is not a stakeholder of the document, no representative of the organization is allowed to access the document in the specified context. Finally, the method verifies user's access permission to the document 503. If there is no access permission link between the user and the document and the access permission may not be deduced in any other way, e.g. using the method described in FIG. 3b, no access is granted. In step 504 the method checks, if all of the steps 501-503 verified OK, i.e. there is a valid chain of trust for the context of the request between the user and the stakeholder organization, there is an ownership (stakeholder) link between the document and the organization and there is an access permission link between the user and the document, the method grants 505 access to the document and/or to the usage context of the document. Otherwise access to the document and/or to the usage context is denied 506.

In a preferred embodiment, the steps of granting 505 or denying 506 access to the document or the step of actual use of the granted access comprise a step of creating a log entry about the action. The log entry may comprise any information used in the process of determining the access rights, including information about users whose trust was part of the chain of trust verified in step 501. Those users may be granted access to the created log entry e.g. for the purpose of enabling them to monitor the use of their trust. Allowing an individual user to monitor the use his/her trust in the system may reduce even significantly, if not almost entirely, the need of administrative users in the system. In an embodiment, the method of the present invention comprises means for e.g. statistically analyzing the created log entries e.g. for the usage of the trust and alerting at least one user if e.g. the usage pattern of the trust granted by the user to other users changes.

FIG. 5b describes a method for inviting and authorizing a second user of a second organization to exchange information, e.g. collaborate, about a document with the first user of a first organization. In step 511, the first user establishes a collaboration session regarding the document in the master data management system (110 in FIG. 1a, 160 in FIG. 1b). The first user has been authorized to access the document and represent the stakeholder in the context of a collaboration session e.g. according to the method of FIG. 5a. Next, a suitable participant user of the master data management system is identified 512, who is allowed to represent the second stakeholder organization in the collaboration context. In an embodiment, the identification of the second user is performed manually e.g. by the first user. In another embodiment, the second user is identified automatically e.g. by the master data management system (110 in FIG. 1a, 160 in FIG. 1b). The automatic identification may utilize e.g. the access event data (173-175 in FIG. 1b) imported from an access event data source (168 in FIG. 1b) or usage log data of the master data management system. Thus, the second user may be selected because of his past activity in a system producing event data to the master data system and/or because of his past activity in the master data management system itself. For example, in an invoice dispute resolution case, the most natural choices for the second user of the collaboration case are the users who have created or worked on the invoice in the seller organization and/or who have participated in earlier dispute resolution cases of the seller organization.

The second participant user identified in step 512 may not have a permission link (204 in FIG. 2a) to the document of the collaboration session. In such case, the first user who has created the collaboration session may in step 513 create the link. The link may be limited to the context of the established collaboration session. If the second user was identified automatically by the master data management system, the system may establish the access permission link between the second user and the document e.g. based on the access event data obtained by the system. Next, in step 514, the second user is notified about the new collaboration session he is requested to participate. When the second user attempts to participate the collaboration session, the method checks in step 515 whether the second user is allowed to access the document of the case in the context of the collaboration session. The checking may be performed e.g. using the method described in FIG. 5a. If the check operation is successful, the second user is granted access to the document in the context of the collaboration session 516. In the other case, access to the document and the collaboration session is denied.

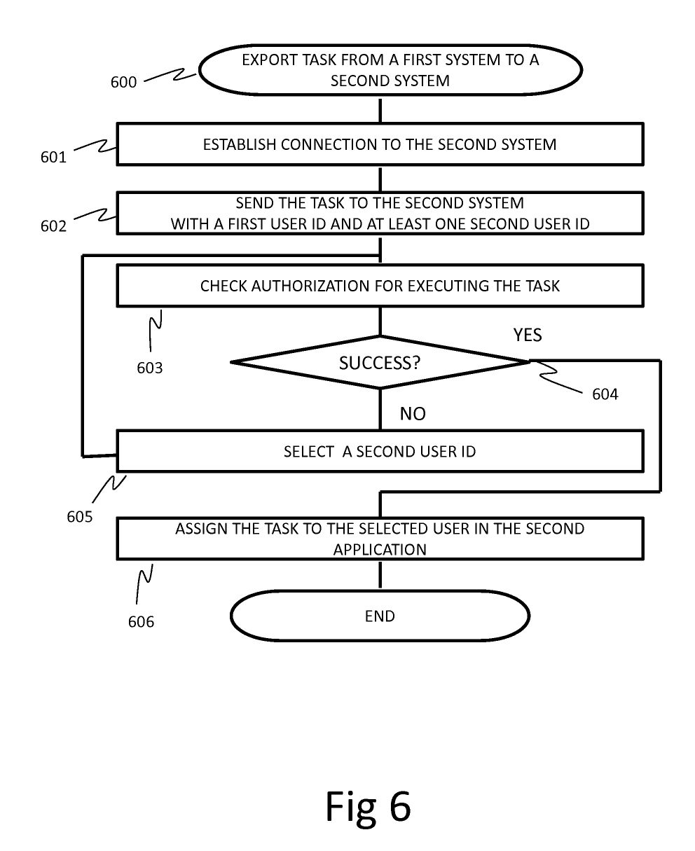

FIG. 6 depicts a method 600 of executing a task created in a first system, e.g. master data management system (110 in FIG. 1a), in a second system, e.g. access event data source (120 in FIG. 1a, 168 in FIG. 1b), e.g. invoice automation system. The task may have been created in the first system e.g. as an end result of a collaboration case, e.g. as the resolution of an invoice dispute case. The resolution may be e.g. an agreement that the disputed invoice may be paid only in part and that the remaining balance is credited in a later incoming invoice. Consequently, a task assigned to a suitable user of the second system needs to be imported from the first system to the second system, e.g. an invoice processing system. For this purpose, a connection is established 601 between the first and the second systems and the task is sent 602 to the second system along with the local user IDs of the first user and at least one second user. The first user may be the user who has participated in the collaboration case in the master data management system and who agreed on the resolution with a user representing the counterparty organization of the collaboration case. The second users may be e.g. the users in the chain of trust of the first user. Using the FIG. 3a as an example, the first user may be e.g. “USER24” (311 in FIG. 3a) and the second users may comprise “USER22” 307 and “USER21” 305.

When the second system receives the task from the first system, the second system checks 603, if the first local user has authorization to execute the task in the second system. If the check operation is unsuccessful, a user from the list of second local users is selected 605 and authorization check is re-executed 603. This is repeated until a user with sufficient rights has been found 604 or the list of users ends. The task is then assigned to the selected user 606 in the second system. As a result, the task is executed in the second system either by the local user ID associable with the first user who has agreed on the task in the first system or by a local user ID associable with a user who trust or is trusted by the first user either directly (“USER22” 307) or through a chain of trust (“USER21” 305).

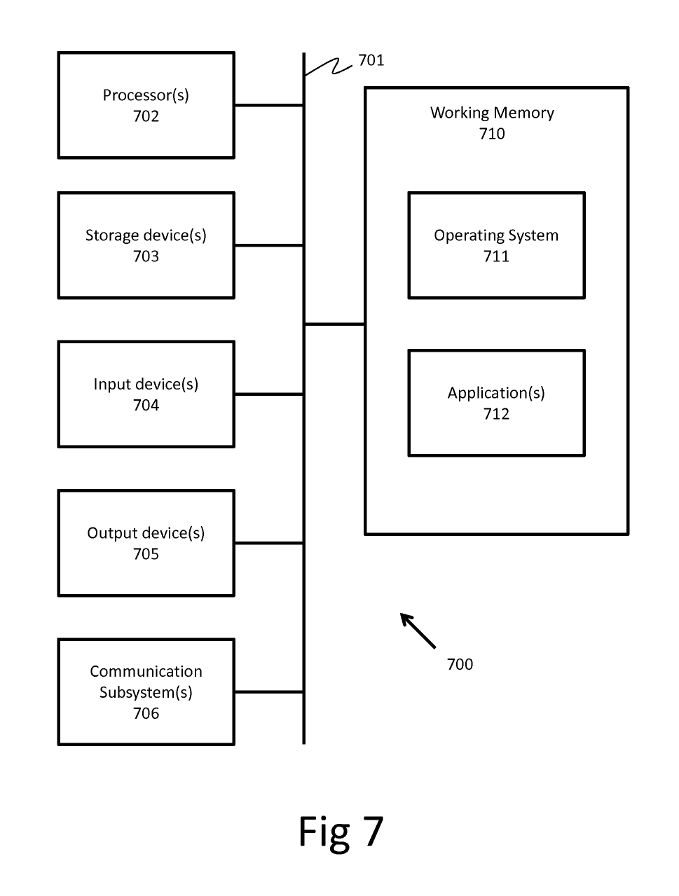

FIG. 7 shows a schematic illustration of one embodiment of a computer system that can perform the methods of the described embodiment. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 701 (or may otherwise be in communication, as appropriate). The hardware elements can include one or more processors 702, communication subsystems 706, one or more input devices 704, which can include without limitation a mouse, a keyboard and/or the like; and one or more output devices 705, which can include without limitation a display device, a printer and/or the like. The computer system 700 may further include (and/or be in communication with) one or more storage devices 703. The computer system 700 also can comprise software elements, shown as being located within the working memory 710, including an operating system 711 and/or other code, such as one or more application programs 712, which may comprise computer programs of the described embodiments, and/or may be designed to implement methods of the described embodiments of a computer-method of the embodiments as described herein.

At least some embodiments include a program storage device readable by a machine, tangibly embodying a program of instructions executable by the machine to perform a computer-executable method of an embodiment of the present invention.

Although specific embodiments have been described and illustrated, the embodiments are not to be limited to the specific forms or arrangements of parts so described and illustrated.

1. A computer executable method for managing user's access to a service adapted to access a data object in a multitenant data management system comprising data of a plurality of entities, wherein the method comprises the steps of:
a. determining data object's association with an entity,
b. determining the existence of a trust relationship between the user and the entity for the user to represent the entity in the context of the service,
c. determining the user's access rights to the data object, and
d. granting the user access to the service, if:
i. the data object is determined to be associated with the entity,
ii. the trust between the entity and the user is determined to be valid in the context of the service, and
iii. the user is determined to have valid access rights to the data object.

2. A method according to claim 1, wherein the context data is adapted to be maintainable by the data management system and shareable by a plurality of services.

3. A method according to claim 1, wherein the service is associated with a plurality of contexts and that the user must be trusted by the entity to represent the entity in all of the associated contexts to use the service.

4. A method according to claim 1, wherein the service is a communication service adapted to exchange information between the user and a second user wherein the second user has a trust relationship in the context of the service with a second representable entity.

5. A method according to claim 1, wherein said step of determining the validity of trust between the entity and the user comprises the step of determining the validity of a chain of trust comprising a plurality of trust objects wherein the chain has at least one object representing a second user who has a trust association with the entity in the context of the service.

6. A method according to claim 5, wherein said step of checking the validity of the chain of trust between the user and the representable entity comprises steps:
a. selecting a trust link associated with the user where the context information of the link matches with the context information of the service of the permission request,
b. traversing to a second trust link specified in the trust link,
c. repeating steps a and b until the end of the chain has been reached, and
d. verifying whether the entity in the end of the chain is an entity that is a stakeholder to the data object to which access permission is requested.

7. A method according to claim 1, wherein said service comprises method comprising steps:
a. creating a second data object comprising a task executable in a second service,
b. sending, with a plurality of user identifiers comprising the first user and/or at least one second user, the second data object to the second service to be executed in the second service using a local user identifier associable with the first user or the second user.

8. A method according to claim 1, wherein said step of determining user's access rights to the data object comprises the step of reading access control information obtained from an external system arranged to manage at least a partial copy of the data object.

9. A method according to claim 1, wherein said step of granting access to the function of the service comprises generating a usage log entry identifying any or any combination of the following:
a. the service function accessed,
b. the data object concerned,
c. the authorized user to whom access was granted, and
d. second users whose trust links were used in the process of verifying the existence and validity of the chain of trust between the authorized user and the entity.

10. A computer readable storage medium comprising a computer program product executable by a processor of a computer for managing user's access to a service adapted to access a data object in a multitenant data management system comprising data of a plurality of entities, wherein the computer program product comprises computer executable instructions for:
a. determining data object's association with an entity,
b. determining the existence of a trust relationship between the user and the entity for the user to represent the entity in the context of the service,
c. determining the user's access rights to the data object, and
d. granting the user access to the service, if:
i. the data object is determined to be associated with the entity,
ii. the trust between the entity and the user is determined to be valid in the context of the service, and
iii. the user is determined to have valid access rights to the data object.
